(19) United States
(12) Patent Application Publication
(10) Pub. No.: US 2016/0310876 A1
(43) Pub. Date: Oct. 27, 2016

(54) FILTRATION SYSTEM AND FILTER ASSEMBLY ASSOCIATED THEREWITH

(71) Applicant: AMIAD WATER SYSTEMS LTD., Kibbutz Amaid (IL)

(72) Inventors: Ra'anan BEN-HORIN, Kibbutz Bet Zera (IL); Yuval SHAMIR, Kibbutz Hagoshrim (IL); Kfir ATIAS, Ein Ya'akov (IL)

(73) Assignee: Amiad Water Systems LTD., Kibbutz Amiad (IL)

(21) Appl. No.: 15/101,280

(22) PCT Filed: Dec. 4, 2014
(86) PCT No.: PCT/IL2014/051059

§ 371 Date: Jun. 2, 2016

Related U.S. Application Data
(60) Provisional application No. 61/911,697, filed on Dec. 4, 2013.

(51) Int. Cl. B01D 29/60; B01D 35/16; B01D 29/68; B01D 29/23; B01D 29/52

(52) U.S. Cl. CPC B01D 29/606; B01D 29/23; B01D 29/52; B01D 29/686; B01D 35/16; B01D 29/688; B01D 2201/082

(57) ABSTRACT

The presently disclosed subject matter is directed to a filtration system. The filtration system comprising a housing and at least one filter assembly extending within the housing. Each of the at least one filter assembly comprising a filter element disposed within the main filtering chamber; a cleaning assembly comprising a suction shaft. The suction shaft comprising at least one suction nozzle along a portion thereof, and being sealed at its one end and configured with at least one exhaust opening at its other end configured for extending within an exhaust chamber. Further comprising a liquid resistant driving mechanism disposed within the exhaust chamber and configured to impart the suction shaft with rotary motion and reciprocal linear motion. The suction shaft is adapted for selectively closing and opening the fluid drain port.

### TECHNOLOGICAL FIELD

The disclosed subject matter relates to fluid filtration systems and filter assemblies used by such systems. More particularly the disclosed subject matter relates to standalone independently activated filter assemblies comprising cylindrical filter element.

### BACKGROUND

Various types of filters are configured with mechanisms for removing suspended solids from solid-entrained liquids. One type among those filters is a cylindrical screen filter. In a cylindrical screen filter, a filter element is generally placed within a sealed housing having inlet and outlet ports. In such an arrangement, liquid introduced into the housing flows from the inside of the filter element out through the perforations in the filter element. The filtered liquid then exits via the outlet of the housing. As a result, the solid material strained from the liquid flowing through the filter is retained on the inside of the filter element. In conventional filters, the retained solids are periodically discharged, using a back flushing liquid, through a manual or automatic valve opened to the atmosphere.

One of the methods used to achieve self-cleaning of the filter element utilizes suction nozzle mechanisms to create suction for pulling out the solids from the filter element which are then expulsed through the open exhaust valve. According to one of such methods, a plurality of nozzles scans the inside surface of the screen in a spiral movement during each cleaning cycle.

### SUMMARY OF THE DISCLOSED SUBJECT MATTER

The disclosed subject matter is directed to filtration systems and filter assemblies.

The filtration system in accordance with the disclosed subject matter comprises a housing, configured with a raw fluid inlet zone comprising an inlet port, a main filtering chamber comprising an outlet port and an exhaust chamber comprising a fluid drain port configured at a top end of the exhaust chamber. The system further comprises at least one filter assembly extending within the housing. The filter assembly comprises a filter element disposed within the main filtering chamber; a cleaning assembly comprising a suction shaft, and a liquid resistant driving mechanism disposed within the exhaust chamber and configured to impart the suction shaft with rotary motion and reciprocal linear motion. The suction shaft comprises at least one suction nozzle along a portion thereof, disposed within the main filtering chamber in close proximity to the filter element and being sealed at its one end and configured with at least one exhaust opening at its other end configured for extending within the exhaust chamber. The suction shaft in accordance with this subject matter is adapted for selectively closing and opening the fluid drain port.

In accordance with the disclosed subject matter the filter system can be provided with two or more filter assemblies, each separately and independently activated. As each of the filter assemblies is a separate and independently activated unit, and as each filter element is associated with a suction/cleaning assembly, this configuration facilitates simultaneous filtering and cleaning within the main space.

As indicated above, this synchronized mode of operation ensures control of the amount of cleaning fluid and the volumetric fluid flow rate discharged from the system, thus preventing unnecessary loss of fluid from the system, e.g. of the contaminants containing fluid.

The independent operation is also beneficial in the event that one or more of the filter assemblies is in need of repair. In such a case, rather than replacing the entire filtration system, the damaged filter assembly is removed and repaired and/or exchanged with a new one. This provides for an easy and cost effective repair of the system.

In accordance with another aspect of the disclosed subject matter a filter assembly is provided. The filter assembly comprises at least one filter element and a cleaning assembly associated with each of the at least one filter assemblies. The cleaning assembly comprises a suction shaft, the suction shaft being sealed at its one end and configured with at least one exhaust opening at its other end and comprising at least one suction nozzle along a portion thereof; and a liquid resistant driving mechanism configured to impart the suction shaft with rotary motion and reciprocal linear motion. The suction shaft is adapted for selectively closing and opening a fluid drain port when received within a filter system housing comprising a fluid drain port.

Any one or more of the following features, designs and configurations can be incorporated in the filtration system and/or one or more filter assemblies according to the present disclosure, either separately or in combinations thereof:
the filter element is a screen type filtering element;
the liquid resistant driving mechanism is fully disposed within the exhaust chamber;
the housing is cylindrical and hydraulically sealed about its top portion by a separating member substantially separating the main filtering chamber from the exhaust chamber and at the bottom end by a cylindrical collar which separates, the inlet port from the main filtering chamber;
the filter element is a cylindrical fine filter element;
the raw fluid inlet zone comprises a coarse filter element coupled to the cylindrical fine filter element through a hydraulically sealing collar;
the driving mechanism is an electric drive motor configured to impart the suction shaft with a rotary motion and a reciprocal axial motion;
the shaft is hollow along a substantive length thereof;
the shaft comprises three main portions including the sealed bottom portion configured as a screw threaded element comprising convolutions thereon, a hollow main suction portion, comprising at least one suction nozzle and a hollow top portion extending from the main suction portion and in fluid communication therewith provided with a toothed outer surface configured to act as a transmission gear against meshing transmission gears associated with the drive motor and activated thereby;
the length of the bottom, screw threaded portion substantially corresponds to the length of the toothed outer surface;
the pitch of the threaded element is equal or less than the diameter of the opening in the one or more suction nozzles;
a diameter of the opening in the coarse filter element is smaller than the opening in the one or more suction nozzles;
the activation of the gear system and the linear movement of the suction shaft in the direction opposite the top end of the exhaust chamber opens the outlet port to the atmosphere and initiating the suction action at the opening of the one or more nozzles;
each filter assembly is provided with its own driving mechanism;
a filtration system comprising more than one filter assemblies and wherein the cleaning action is imparted selectively by one or more of the associated cleaning assemblies this configuration facilitates simultaneous filtering and cleaning within the main filtering chamber;
wherein the cleaning action is imparted by all cleaning assemblies associated with the more than one filter assemblies;
each suction shaft is provided with a plurality of nozzles extending along a longitudinal axis of the filter element;
a self cleaning cycle is initiated depending on a predetermined maximum differential pressure DP between the raw fluid and the filtered fluid;
length of the bottom portion of the suction shaft substantially corresponds to the length of the toothed surface of the top portion thereof;
the pitch of the threaded bottom portion is equal to or less than the diameter of the opening in the suction nozzle; and
in a system comprising two or more filter assemblies/filter elements, the inlet to each of the main/fine filtering element is separated for each of the coarse filtering elements by a partition.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a perspective side view of a filter system in accordance with the disclosed subject matter, with the housing made translucent for visualization;

FIG. 1B is a side view of the filtration assembly seen in FIG. 1A;

FIG. 2 is a longitudinal section along line A-A in FIG. 1A, with the filter system in a filtration mode;

FIG. 3 is a longitudinal section along line A-A in FIG. 1A, with the filter system in a cleaning mode;

FIG. 4A is a perspective side view of a filter system in accordance with another example of the disclosed subject matter, with the housing made translucent for visualization;

FIG. 4B is a perspective view of the filtration assembly seen in FIG. 4A;

FIG. 4C is a perspective top exploded view of the inlet zone of the system housing of FIG. 4A;

FIGS. 5A and 5B are a longitudinal section along line B-B in FIG. 4A, in a front view and a perspective side view with the filter system in a filtration mode;

FIGS. 6A and 6B are a longitudinal section along line B-B in FIG. 4A, in a front view and a perspective side view with the filter system in a cleaning mode; and

FIGS. 7A and 7B are a longitudinal section along line B-B in FIG. 4A, in a front view and a perspective side view with the filter system in a combined filtration and cleaning mode;

FIGS. 8A and 8B are a detailed enlarged view of the portion marked C in FIG. 1B, with a one way screw and an automatic reversing screw, respectively.

### DETAILED DESCRIPTION OF EMBODIMENTS

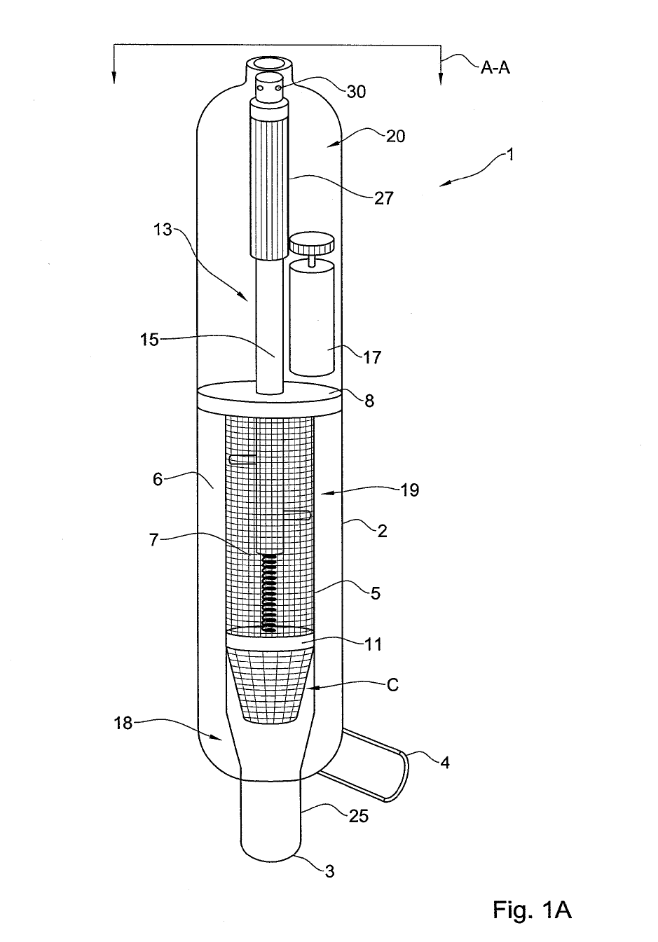

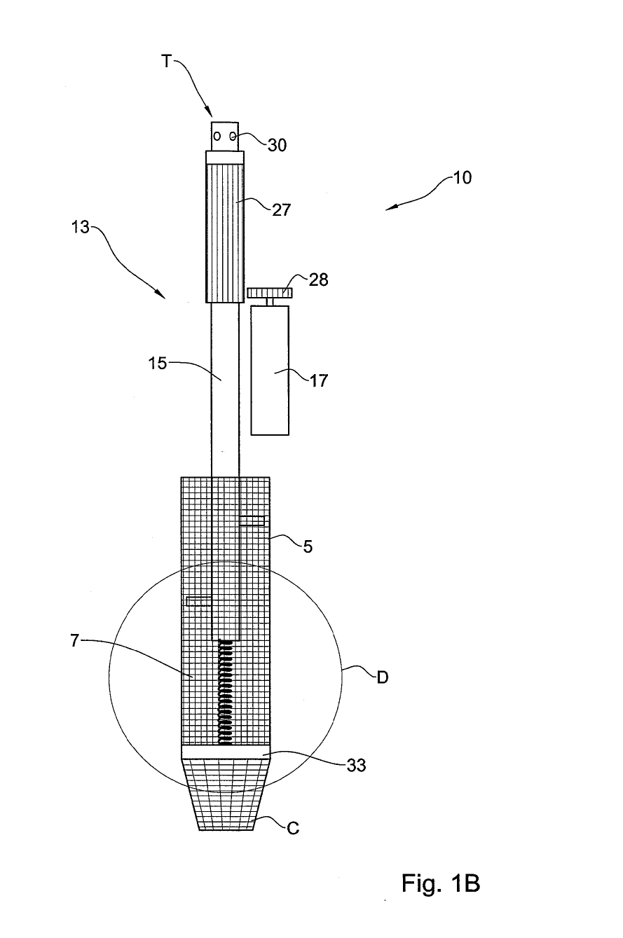

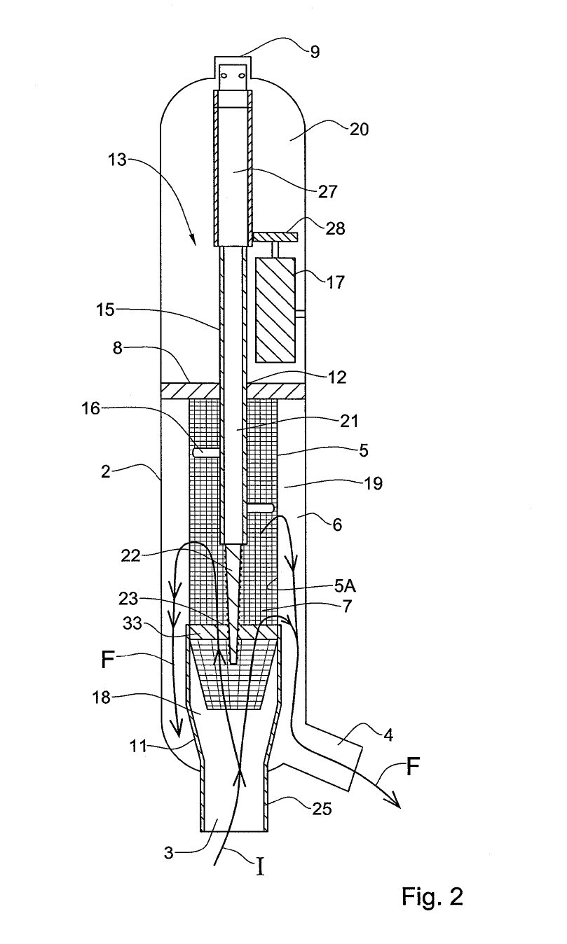

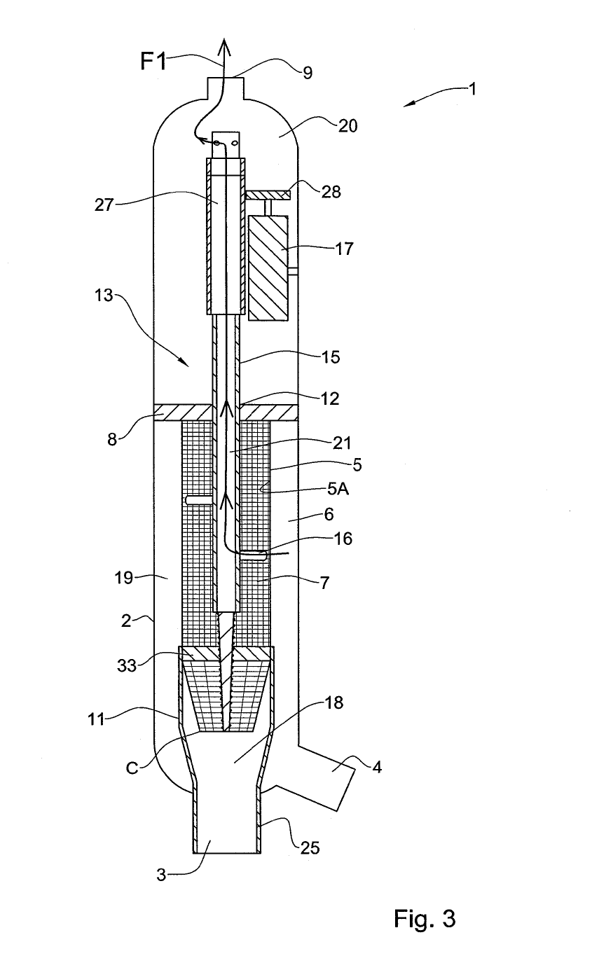

Referring to FIGS. 1A, 2, and 3, there is illustrated a filter system 1 according to the present disclosed subject matter, comprising a cylindrical housing 2 (seen in cross section in FIGS. 2 and 3 for visualizing inside components of the filter system) and configured with an inlet port 3, an outlet port 4, and a drain fluid outlet port 9. The housing 2 comprising the filtration assembly 10 (best seen in FIG. 1B) is divided into three general zones and comprises a raw fluid inlet zone 18, a main filtering chamber 19 and an exhaust chamber 20. In the present example, the cylindrical housing 2 is hydraulically sealed at its top portion by a flange 8 which separates the main filtering chamber 19 from the exhaust chamber 20 and at the bottom end by a cylindrical collar 11 which separates, the inlet port 3 from the main filtering chamber 19, i.e., by preventing direct flow communication of the untreated fluid into the main filtering chamber 19. In accordance with some modifications of the disclosed subject matter rather than hermetically sealing the main filtering chamber 19 from the exhaust chamber 20, small openings/circumferential space can be provided in the flange 8 surrounding the filtration assembly 10 when inserted therethrough to prevent friction between the flange 8 and the filtration assembly 10.

A cylindrical fine filter element 5 is secured to the collar 11 thus allowing fluid flow through the inlet port 3 into the filter element 5. It is however appreciated that other forms of separation and articulation of the filter element 5 to the housing can be applied, such as by provision of an endplate at the bottom end thereof.

The fine filter element 5, having a smaller diameter than that of the housing 2, rests concentrically within the main filtering chamber 19 of the housing 2, creating an outer space 6 (namely, a filtered fluid chamber) between an inside surface of the housing 2 and an outside surface of the filter element 5. An inner space 7 (also referred to as a raw fluid chamber) extends within the cylindrical filter element 5. The filter element 5 is a screen-type filter. It will be appreciated that any variation of a fine filtering element is envisioned, such a filter element should have a substantially cylindrical shape. Thus, for example, the screen of the cylindrical element can be folded in a zigzag manner or a bellows like fold thus providing, e.g. for a larger surface area for filtration. Alternatively, the filtering element can be a disc type element.

The raw fluid inlet zone 18 comprises a coarse filter element C. In the illustrated example the coarse filter element is a basket like concave member. The coarse filter element C is designed to protect the fine filter element 5 from large dirt particles by filtering large particles on its outer surface. The coarse filter element C is coupled to the cylindrical fine filter element 5. The fine filter element 5 is supported and capped by a hydraulically sealing collar 11. The sealing prevents the unfiltered raw water containing large particles from entering the main filtration chamber 19 of the housing 2 and in particular prevents unfiltered fluid from flowing into the outer space 6. In the present example, the filtrate of the coarse filter element C serves as the raw fluid to be treated by the fine filter element 5 and hereinafter reference made to raw fluid refers to fluid pre-filtered by the coarse filter element C.

The filter system 1 further comprises a suction/cleaning assembly generally designated 13 (best seen in FIGS. 1B, 2 and 3). The assembly 13 has a concentrically fitted hollow suction shaft/pipe 15 and a driving mechanism, in this example, an electric drive motor 17. The electric drive motor 17 is configured to impart the shaft 15 with a rotary motion and a reciprocal axial motion as will be explained hereinbelow (it will be appreciated that the rotary motion can also be reciprocal). The shaft 15 is hollow along a substantive length thereof and is sealed on one end, while the other end extends within and is open to the exhaust chamber 20 comprising several openings 30 at its top end portion T (best seen in FIG. 1B).

The shaft 15 can be roughly divided into three main portions as follows: the sealed bottom portion configured as a screw threaded element 22 comprising convolutions thereon, a hollow main suction portion 21, comprising a plurality of suction nozzles 16 and a hollow top portion 27 extending from the main suction portion 21 and in fluid communication therewith provided with a toothed surface, configured to act as a transmission gear against meshing transmission gears 28 associated with the drive motor 17 and activated thereby. It will be appreciated that while in this example two transmission gears are used to provide the mechanism with stability, less or more gears can be used, Mutatis Mutandis. As indicated, the top portion 27 is provided with openings 30 at its top end, the openings 30 being in fluid communication with the hollow interior of the shaft 15. It will be appreciated that in the illustrated example, the length of the bottom, screw threaded portion 22 substantially corresponds to the length of the toothed surface, i.e. the gear, of the top portion 27. In addition, the pitch of the threaded element 27 is equal or less than the diameter of the opening in the suction nozzle 16. The assembly 13 extends through the flange 8 and is surrounded by a mechanical seal 12 allowing little to no fluid to flow between the portions of the housing. The seal 12 primarily protects against leakage of any fluid within the exhaust chamber 20 back into the main filtering chamber 19 and maintains fluid pressure during various stages of operation of the filter. The seal 12, however, allows for axial and rotational motion of the assembly 13 relative to the filter element 5.

The assembly 13 as indicated is associated with an electric drive motor 17 connected thereto and disposed near its top portion, extending within the exhaust chamber 20. The drive motor 17 is mounted above the flanged endplate 8 within the filter housing 2. In accordance with the disclosed subject matter the drive motor 17 is adapted to operate in fluid and is liquid resistant as the drive motor 17 is entirely immersed within fluid at the exhaust chamber 20. The top end of the drive motor is fitted with a transmission gear 28. Transmission gear 28 is configured to be associated with the toothed surface of the top portion 27 of the shaft 15 thereby forming a rotational transmission system between the drive motor 17 and the shaft 15.

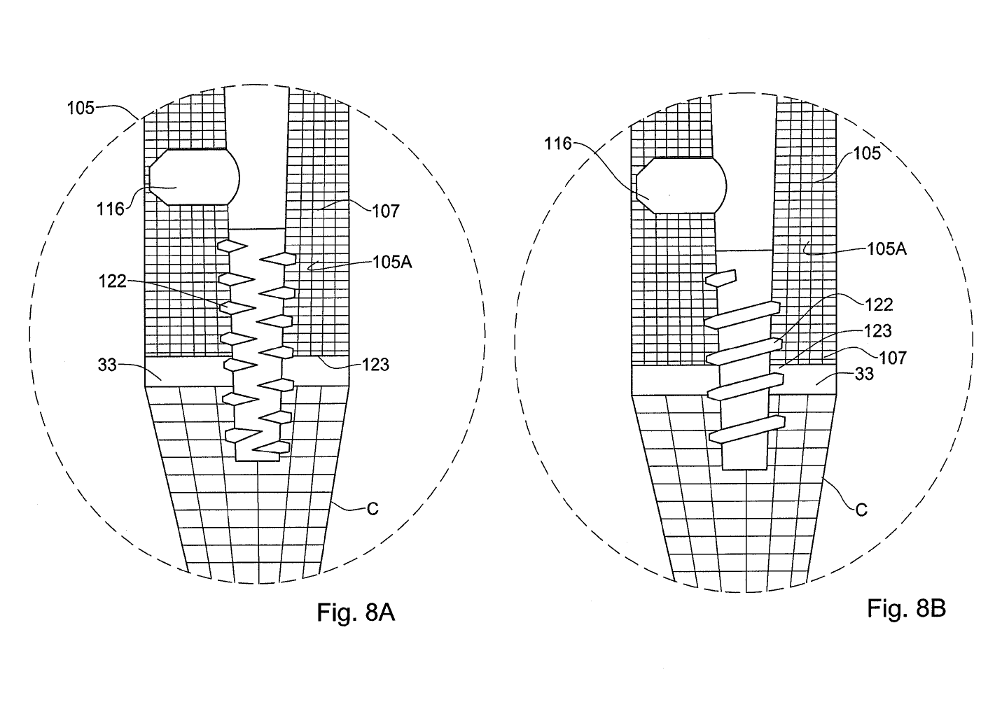

In operation, when the rotational transmission system is activated by the drive motor 17 rotating the transmission gear 28 which meshes with the toothed surface of the top portion 27 of the shaft 15, a corresponding axial displacement of the shaft 15 occurs when the screw threaded portion 22 is rotated and is imparted with a reciprocal linear motion as it is screwed through a nut collar 23 (best seen in FIGS. 8A and 8B as 123) fitted just above the coarse filter element C. The nut collar 23 in accordance with this example is provided in a perforated separation plate 33 provided between and articulated to the coarse filter element C, and the fine filter element 5. It will be noted that the separation plate 33 is perforated to allow fluid flow from the coarse filter element C into the space 7 defined by the filtering element 5 during the filtration cycle.

According to one example of the disclosed subject matter, inlet port 3 extends through inlet pipe 25 which communicates with inner space 7 of filter element 5 through coarse filter element C, and outlet port 4 communicates with outer space 6 of main filtering chamber 19.

In filtration mode, the unfiltered raw fluid is introduced through inlet port 3 (the flow path I is illustrated in FIG. 2 by solid arrow), passes through the coarse filter element C, and enters the inner space 7 within the filter element 5. The raw fluid then passes through the filter element 5 and the resulting filtrate enters outer space 6 (flow path F is illustrated in FIG. 2 by solid arrows) and is then discharged through outlet port 4, e.g. to a collection tank (not seen) as filtered fluid. In the filtering process the suspended material accumulates on the inner surface of the fine filter element 5. As a result the suspended material clogs the filter element 5. The controller associated with the filtration system is configured to sense the pressure differential, which will be referred to as DPI of a pre-set value, e.g. 0.5 bar, between the outer space 6 and the inner space 7 and initiates a cleaning cycle.

The cleaning cycle is performed as follows. First, the self-cleaning cycle is initiated by a pressure differential switch which activates the drive motor at a point when dirt material is accumulated on the fine filter element 5 (i.e. when the pressure differential DPI across the fine filter element 5 reaches a pre-set value), and/or by a timer which activates the drive motor 17 at predetermined time intervals. The space 7 within the filter element 5 has a higher (‘positive’) pressure relative to the pressure in the space outside the filter element 5, the controller sensing the differential pressure DPI activates the drive motor 17. Upon the initiation of the cleaning cycle, the electric drive motor 17 initiates the rotary motion of the gear system over the shaft 15. As the shaft is rotated, the screw threaded portion 22 of the shaft 15 translates the rotational motion into a reciprocal linear motion as it is screwed through the nut collar 23. This causes the shaft 15 and the suction nozzles 16 thereon to rotate and axially reciprocate, thus scanning substantially the entire inner surface 5A of the filter element 5.

With the activation of the gear system and the linear movement of the shaft 15 in the downwards direction, the drain fluid outlet port 9 is opened as the top end of the shaft 27 (acting as an integral valve) moves therefrom, thus causing the exhaust chamber 20 to open to atmosphere. In turn, this causes the pressure within the exhaust chamber and within the shaft to drop, causing a differential pressure DPII between the inner space 7 within the filter element and the hollow space within the shaft 15. Thus, suction is created at the opening of the nozzles 16. This suction draws suspended material that has been deposited on to the inside surface 5A of the fine filter element 5 during filtration, into the hollow shaft 15 through the nozzles 16. As the raw fluid continues to flow through the inlet port 3 and into the space 7, nozzles 16 draw therein both the suspended material and some of the raw fluid. The suspended material/mass together with the raw fluid is then flushed into the flushing cell/exhaust chamber 20 through the openings 30 at the top portion 27 (integral valve) of the shaft 15 and is discharged/flushed out through the flushing/drain fluid outlet port 9 outside the housing 2. The flushing flow path F1 is illustrated in FIG. 3 by solid arrows. It will be appreciated that the exhaust chamber 20 is continuously filled with fluid exhausted through the shaft 15.

It will be appreciated that during the cleaning cycle, the drive motor 17 is configured to activate the gears 27 and 28 so as to move therein the main suction portion 21 of the shaft 15 in both the downwards and the upwards directions as desired. Alternatively the threaded screw portion 22 can be configured as a self reversing screw, as demonstrated in FIG. 8B allowing a reciprocated bi-directional movement achieved by using, e.g. a follower blade in the nut collar 23. Use of a self reversing screw can also facilitate different speeds of the linear reciprocal motion in the upwards direction and the downwards direction.

While the filtration and the cleaning cycles have been exemplified and discussed as separate modes of operation, it will be appreciated that during the cleaning cycle, as the pressure differential changes, simultaneous filtration and cleaning is performed by the filtration system. For as long as the outlet port 9 of the exhaust chamber 20 is open to the atmosphere, the cleaning cycle is continuous simultaneously with the filtration cycle. Thus the cleaning cycle will be halted when the top end (i.e. the integral valve) of the shaft 17 reaches the outlet port 9 and locks the exhaust chamber 20 to the atmosphere. This mode of operation, and in particular the utilization of the integral valve 27 (i.e. its opening of the port 9 in response to the DPI and the activation of the drive motor and the closing of the port as the cleaning shaft 15 reaches the port 9, simultaneously completing the cleaning cycle and locking of the system to the atmosphere, without any delay which might cause loss of cleaning fluid from the exhaust chamber 20), decreases the loss of the amount of cleaning fluid and the volumetric fluid flow rate discharged from the system, thus preventing unnecessary loss of fluid from the system 1.

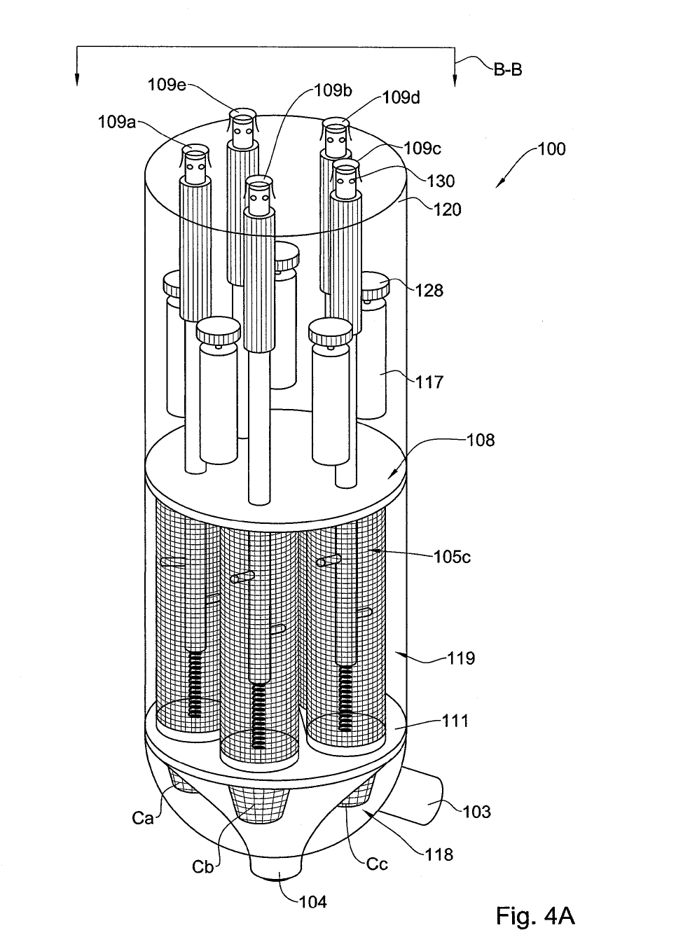

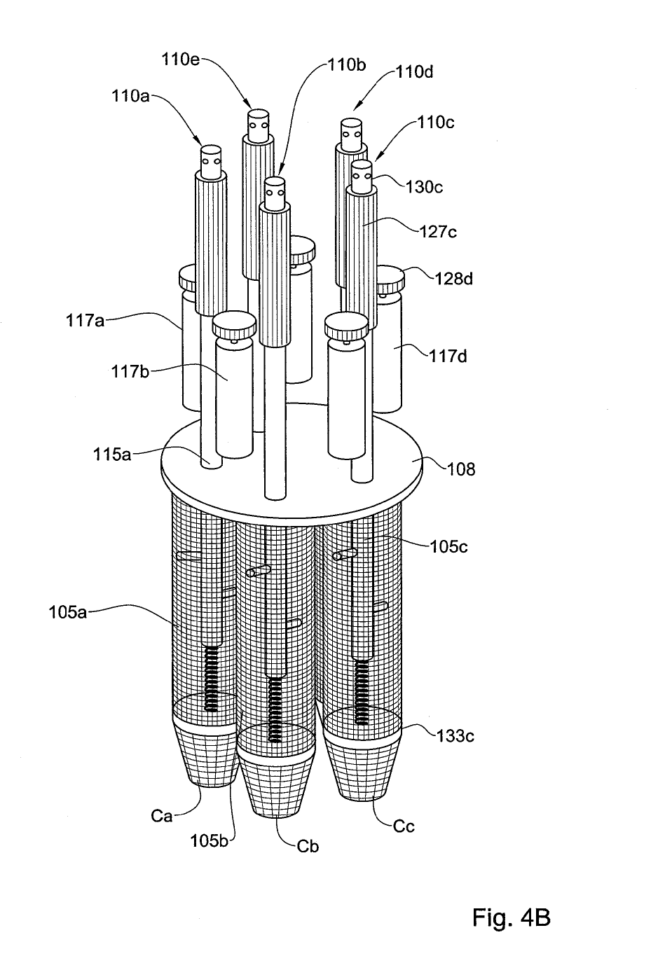

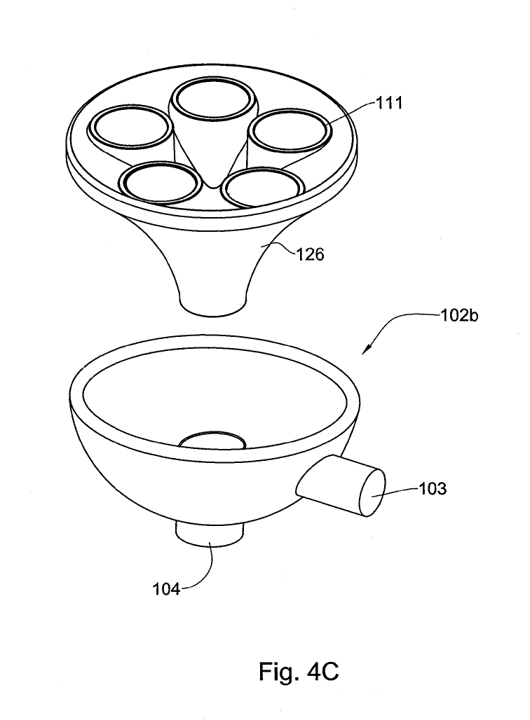

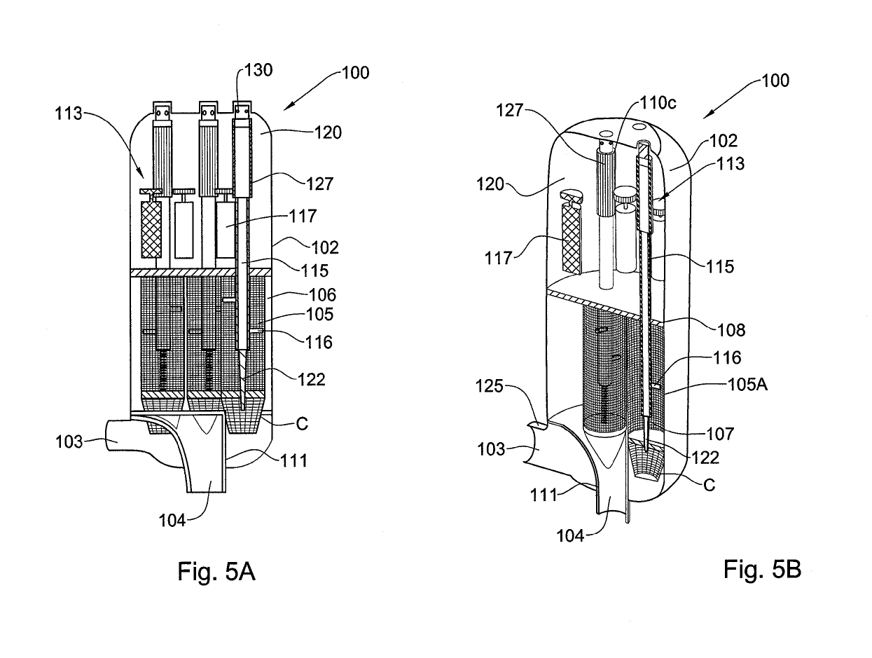

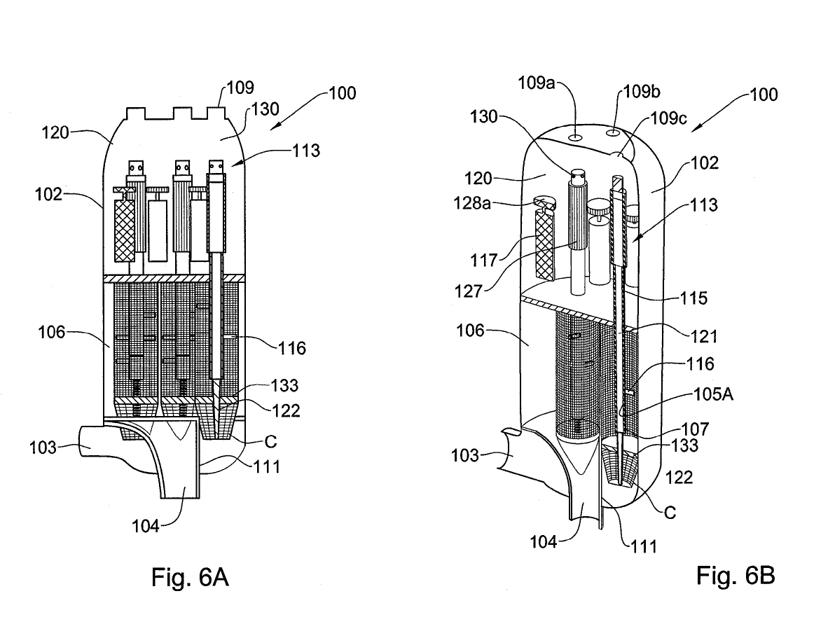

Another embodiment of the disclosed subject matter is illustrated in FIGS. 4 to 7 in which similar elements are identified by same numerals upped by 100. In accordance with this embodiment, the filter system generally designated 100 is provided with a plurality of filtration assemblies 110 (similar to the filtration assembly 10 seen in FIG. 1B and in this example five filtration assemblies 110a-110e, as seen in FIG. 4B, are provided although in the sectioned front view only three are seen) symmetrically disposed within the housing 102, with their longitudinal axis parallely disposed within the housing 102.

The housing 102 is configured with a main filtering chamber 119 accommodating the fine filtering elements 105a-105e (only three seen in FIG. 4B) of the filtration assemblies 110a-110e and provided with outlet ports 109a-109e, seen in FIG. 4A, a fluid inlet zone 118 fitted with an inlet port 103 extending below a main filtration chamber 119 fitted with a fluid outlet port 104 and a top exhaust chamber 120 separated from the main filtration chamber 119 by a flange 108, seen in FIGS. 4A and 4B. The exhaust chamber 120 accommodates the five drive motors 117a-117e each of which is associated with the corresponding suction/cleaning assembly and the filter element 105a-105e of the filter assemblies 110a-110e. The exhaust chamber 120 is configured at its top end (the top surface of the housing 102) with the corresponding five drain fluid outlet ports 109a-109e associated with each of the five filter assemblies 110a-110e. As such, the housing disclosed with reference to the previous example is modified to comprise at its top end openings 130 associated with each of the filter assemblies, the flange 108 is configured with openings 112a-112e to receive the shaft of each of the filter assemblies, and the fluid inlet zone 118 of the housing 102 is configured with a partition collar 111, seen in FIG. 4C, to accommodate each of the coarse filter elements Ca—Ce (only three of which are seen in FIG. 4B) separating the raw fluid inlet zone from the main filtration chamber. The partition collar 111 is a unitary structure for all five assemblies (best seen in FIG. 4C). As can further be seen in FIG. 4C, the partition collar 111 resembles a funnel-like structure and is mounted within the inlet zone 118 of the housing 102. The center of the partition collar 111 defines an outlet pipe 126, the pipe being received in the outlet port 104 of the housing. The raw fluid inlet zone 118 is defined by the space surrounding the outlet pipe of the partition collar 111 and the bottom portion 102B of the housing 102.

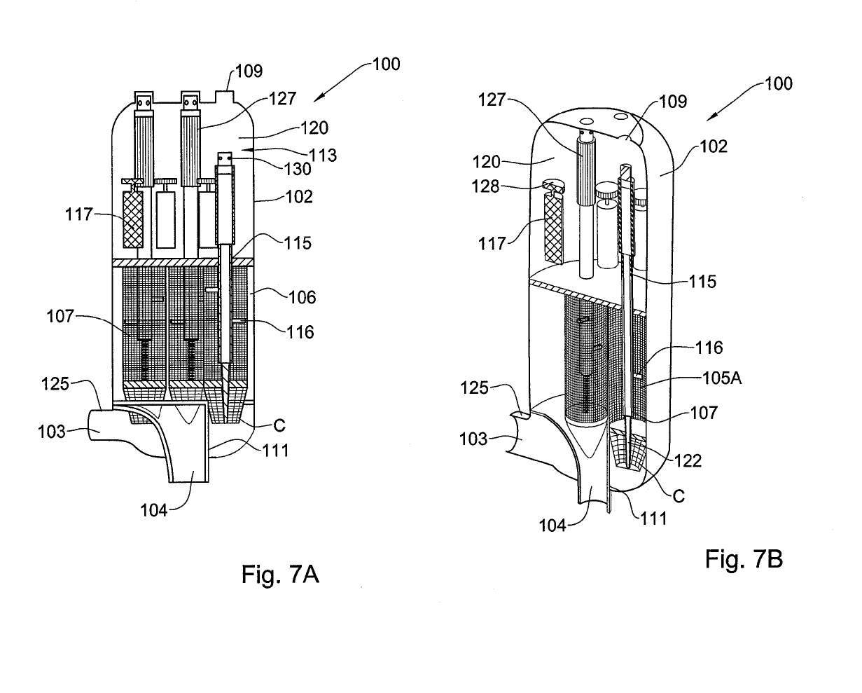

As each of the filter assemblies is a separate and independently activated unit, and as discussed above, each filter element is associated with a suction/cleaning assembly 113, this configuration facilitates simultaneous filtering and cleaning within the main space. For example, one or more of the filter assemblies 110 can be in a cleaning mode while one or more of the remaining filter assemblies filters the raw fluid (seen in FIGS. 7A and 7B). As discussed above with reference to the filtration system 1 comprising a single filter assembly 10, each assembly 110 in the illustrated example is configured to continue the cleaning process simultaneously with filtration for as long as the respective drain port 109 is open to the atmosphere, and the cleaning shaft is activated by the drive motor.

As indicated above, this synchronized mode of operation ensures control of the amount of cleaning fluid and the volumetric fluid flow rate discharged from the system, thus preventing unnecessary loss of fluid from the system.

The independent operation is also beneficial in the event that one or more of the filter assemblies is in need of repair. In such a case, rather than replacing the entire filtration system, the damaged filter assembly is removed and repaired and/or exchanged with a new one. This provides for an easy and cost effective repair of the system.

1. A filtration system, comprising:
a housing, configured with a raw fluid inlet zone comprising an inlet port, a main filtering chamber comprising an outlet port and an exhaust chamber comprising a fluid drain port configured at a top end of the exhaust chamber;
at least one filter assembly extending within the housing, the filter assembly comprising:
a filter element disposed within the main filtering chamber; a cleaning assembly comprising a suction shaft, the suction shaft comprising at least one suction nozzle along a portion thereof, disposed within the main filtering chamber in close proximity to the filter element and being sealed at its one end and configured with at least one exhaust opening at its other end configured for extending within the exhaust chamber;
a liquid resistant driving mechanism is disposed within the exhaust chamber and is configured to impart the suction shaft with rotary motion and reciprocal linear motion;
the suction shaft is adapted for selectively closing and opening the fluid drain port.

2. A filtration system according to claim 1, wherein the housing is cylindrical and hydraulically sealed about its top portion by a separating member substantially separating the main filtering chamber from the exhaust chamber and at the bottom end by a cylindrical collar which separates the inlet port from the main filtering chamber.

3. A filtration system according to claim 1, wherein the filter element is a cylindrical fine filter element.

4. A filtration system according to claim 1, wherein the filter element is a screen type filtering element.

5. A filtration system according to claim 1, wherein the liquid resistant driving mechanism is fully disposed within the exhaust chamber.

6. A filtration system according to claim 1, wherein the raw fluid inlet zone comprises a coarse filter element coupled to the fine filter element through a hydraulically sealing collar.

7. A filtration system according to claim 1, wherein the driving mechanism is an electric drive motor configured to impart the suction shaft with a rotary motion and a reciprocal axial motion.

8. A filtration system according to claim 1, wherein the shaft is hollow along a substantive length thereof.

9. A filtration system according to claim 1, wherein the shaft comprises three main portions including the sealed bottom portion configured as a screw threaded element comprising convolutions thereon, a hollow main suction portion, comprising at least one suction nozzle and a hollow top portion extending from the main suction portion and in fluid communication therewith provided with a toothed outer surface configured to act as a transmission gear against meshing transmission gears associated with the drive motor and activated thereby.

10. A filtration system according to claim 9, wherein the length of the bottom, screw threaded portion substantially corresponds to the length of the toothed outer surface.

11. A filtration system according to claim 9, wherein the pitch of the threaded element is equal or less than the diameter of the opening in the one or more suction nozzles.

12. A filtration system according to claim 9, wherein a diameter of the opening in the coarse filter element is smaller than the opening in the one or more suction nozzles.

13. A filtration system according to claim 1, wherein the activation of the gear system and the linear movement of the suction shaft in the direction opposite the top end of the exhaust chamber opens the outlet port to atmosphere initiating the suction action at the opening of the one or more nozzles.

14. A filtration system according to claim 1, wherein each filter assembly is provided with its own driving mechanism.

15. A filtration system according to claim 1, comprising more than one filter assemblies and wherein the cleaning action is imparted selectively by one or more of the associated cleaning assemblies facilitating simultaneous filtering and cleaning within the main filtering chamber.

16. A filtration system according to claim 15, wherein the cleaning action is imparted by each of the cleaning assemblies associated with the more than one filter assemblies.

17. A filtration system according to claim 1, wherein each suction shaft is provided with a plurality of nozzles extending along a longitudinal axis of the filter element.

18. A fluid filtration unit according to claim 1, wherein a self cleaning cycle is initiated depending on a predetermined maximum differential pressure DP between the raw fluid and the filtered fluid.

19. A fluid filtration unit according to claim 9, wherein length of the bottom portion of the suction shaft substantially corresponds to the length of the toothed surface of the top portion thereof.

20. A fluid filtration unit according to claim 9, wherein the pitch of the threaded bottom portion is equal or less than the diameter of the opening in the suction nozzle.

21. A filter assembly comprising:
a filter element;
a cleaning assembly comprising a suction shaft, the suction shaft being sealed at its one end and configured with at least one exhaust opening at its other end and comprising at least one suction nozzle along a portion thereof;
a liquid resistant driving mechanism configured to impart the suction shaft with rotary motion and reciprocal linear motion;
the suction shaft being adapted for selectively closing and opening a fluid drain port when received within a filter system housing.
